(19) United States
(12) Patent Application Publication
(10) Pub. No.: US 2026/0226791 A1
(43) Pub. Date: Aug. 6, 2026

(54) A ROLLABLE DOOR CURTAIN FOR A ROLL-UP DOOR ASSEMBLY, A ROLL-UP DOOR ASSEMBLY COMPRISING THE ROLLABLE DOOR CURTAIN, AND A METHOD FOR PRODUCING THE ROLLABLE DOOR CURTAIN

(71) Applicant: Assa Abloy Entrance Systems AB, Landskrona (SE)

(72) Inventor: Patrik SCHOONJANS, Opwijk (BE)

(21) Appl. No.: 19/152,991

(22) PCT Filed: Feb. 6, 2024
(86) PCT No.: PCT/EP2024/052844

§ 371 Date: Aug. 1, 2025

(30) Foreign Application Priority Data
Feb. 17, 2023 (SE) 2330092-4

(51) Int. Cl. E06B 9/13; E06B 9/17

(52) U.S. Cl. CPC E06B 9/13; E06B 9/17; E06B 2009/17092

(57) ABSTRACT

ASSA ABLOY Entrance Systems AB has developed a rollable door curtain (100) for a roll-up door assembly (200) is provided. The rollable door curtain (100) comprising: a rollable curtain member (102) having a first fold line (104) forming an indentation into said rollable curtain member (102); wherein the first fold line (104) divides the rollable curtain member (102) into a first segment (106) and a second segment (108); and wherein the rollable curtain member (102) is foldable, along the first fold line (104), between an unfolded state (110), in which the first and the second segments (106, 108) are arranged in the same plane and a folded state (112), in which the first and the second segments (106, 108) are folded at least partly on top of each other. A roll-up door assembly (200) for covering a door opening (202) and a method for producing the rollable door curtain (100) are further provided.

### TECHNICAL FIELD

The present disclosure relates to roll-up doors in general. More specifically, the disclosure relates to a rollable door curtain for a roll-up door assembly, a roll-up door assembly comprising the rollable door curtain and a method for producing the rollable door curtain.

### BACKGROUND ART

High-speed roll-up doors have many advantages in situations requiring fast-moving and/or high-volume traffic in and out of a specific area, for instance, to allow for reduced temperature loss and contamination while moving products or parts in and out of a clean room, a food production facility or a machine protection area.

This is achieved by the high-speed roll-up doors comprising rollable door curtains that can be rolled or un-rolled about a rotating axle at high speed, allowing for door openings or similar apertures of large dimensions to be opened and closed in a very short time.

The dimensions of the high-speed roll-up doors depend on application and they are generally having a surface area in the range of 5 to 20 square meters, but can be larger. Hence, the roll-up doors are therefore particularly suitable for closing apertures between two rooms or between a room and the outside in warehouses, workshops, shops, laboratories, and the like.

The rollable door curtains may, however, be exposed to several different external factors, such as wind and rain, impacts with persons or vehicles in movement or with objects placed in the trajectory of the rollable door curtain. This requires the rollable door curtains to be robust and durable as well as lightweight.

The large dimensions and material requirements needed in industry pose further challenges to the manufacturer, transporter and handler of the rollable door curtains. In particular, bulky rollable door curtains are difficult to stack and move efficiently around leading to higher material handling and transportation costs. Put differently, the size of the rollable door curtains and the packaging are problematic. Products are packed in crates or on racks having several meters length for shipping to the customer, making the shipment very expensive.

There is thus a need for improvements in the industry of roll-up doors and rollable door curtains. There is in particular a need for rollable door curtains that allow for easier handling and cost-efficient transport. There is also a need to increase sustainability and reduce the environmental foot print for roll-up doors.

### SUMMARY

It is an object of the present disclosure to mitigate, alleviate or eliminate one or more of the above-identified deficiencies and disadvantages in the prior art and solve at least the above-mentioned problems.

According to a first aspect there is provided a rollable door curtain for a roll-up door assembly. The rollable door curtain comprising:
a rollable curtain member having a first fold line forming an indentation into said rollable curtain member;
wherein the first fold line divides the rollable curtain member into a first segment and a second segment;
wherein the rollable curtain member is foldable, along the first fold line, between an unfolded state, in which the first and the second segments are arranged in the same plane and a folded state, in which the first and the second segments are folded at least partly on top of each other; and
wherein the rollable curtain member extend in a longitudinal direction X1 between two opposite transversal edges and wherein the first fold line spans between the transversal edges, the rollable curtain member being arranged to be rolled up or unrolled along the longitudinal direction X1 both upon being in the unfolded state or being in the folded state.

An advantage being that the rollable door curtain is foldable in an efficient manner. An easier handling of the rollable door curtain is thereby achieved. The rollable door curtain may moreover be folded while mitigating damage or wrinkling of the segments. Put differently, a rollable door curtain is provided that can be folded in such a manner that the folds do not harm the material of the rollable door curtain or leave visible markings thereon. The provided rollable door curtain may further be folded and rolled thereafter leading to a simpler handling thereof. The rollable door curtain that may also be stacked in an efficient manner. By way of example, several folded rollable door curtains may be stacked on top of each other reducing for instance storage space.

The rollable door curtain may further be folded and rolled up in such a way that the final product may be compact in size and may be packed inside a small crate, e.g. a euro pallet box. Using standardized pallets makes it possible to increase the number of rollable doors curtains that are loaded onto a truck. This volume reduction makes transportation more efficient, saving cost and reducing emissions. Shipment of a replacement curtain may also be cheaper as the package will be smaller.

The indentation may be formed by a cut in the rollable curtain member. The formation of the indentation may in some examples be referred to as cut scoring. In other words, the indentation may be formed by scoring. The scoring may be a cut. The cut may extend partially through the rollable curtain member. Thus, the cut scoring may leave a partial cut or an indent in the rollable curtain member. A stress point may thereby be formed to provide a fold line. Put differently, the rollable curtain member may comprise a recess. The recess may advantageously be aligned with fibres of the material of the rollable curtain member.

The indentation may extend in depth partially through the thickness of the rollable curtain member.

The indentation may advantageously be just deep enough to adequately serve the purpose of providing an efficient folding along the fold line.

By way of example, for a rollable curtain member having a thickness of about 1 mm, the indentation may be formed with a depth relative to the thickness of the rollable curtain member that is within the range from between about 10% to about 60%, more preferably within the range from between about 20% to about 40%. In the case of a thicker rollable curtain member, the indentation may be deeper due to a decrease in foldability with increased thickness.

By way of example, the depth of the indentation may be about half of the thickness of the rollable curtain member to allow for efficient folding. The suitable depth of the indent may depend of the material parameters as well as on the thickness of the rollable curtain member. A too shallow cut may result inaccurate folding. A too deep cut may result in tear.

The indentation may be understood as a depression or recess formed in the rollable curtain member. The indentation may form a straight line.

The indentation may be a cut.

The indentation may be formed by creasing, the creasing causing the rollable curtain member to be weakened along the first fold line such that the rollable curtain member is easier to fold. The rollable curtain member may be compressible. Put differently, the rollable door curtain may be formed by a compressible material.

The first fold line should be construed as a portion of the rollable door curtain at which it is arranged to be folded. The first fold line may be understood as to form a fold axis. The folding axis may be parallel to a longitudinal axis X1.

The wording “rollable” should here be interpreted as the segments, and thereby the rollable door curtain, being arranged to be rolled. The rollable curtain may thereby be arranged to be rollable around a rotational axis. The rotational axis being parallel to a transversal direction X2. In other words, the rotational axis being perpendicular to the longitudinal direction X1. Hence, the transversal direction X2 being perpendicular to the longitudinal direction X1. The rollable door curtain is further be understood to be rollable in both the folded and unfolded state.

The material or materials of the rollable curtain member may be understood as being flexible.

The wording on “at least partly on top of each other” should be construed as one of the segments, when the rollable door curtain is in the folded state, is placed on the other segment such that the two segments are at least partly overlapping. Put differently, the respective main surfaces of the two segments may be in contact and at least partly overlap. One part of the rollable door curtain is thereby laid over another part of the same. In other words, in the folded state the first segment and the second segment may be understood to be placed in a first plane and a second plane, respectively, wherein the first and the second planes are parallel planes. The first and the second planes may be in contact with each other. The first and the second segments may have the same or different dimensions.

The wording “span between the transversal edges” should in this context be understood as the first fold line spans major part between the transversal edges. The major part may, by way of example, may be in the order of 90 to 95 percent of the distance between the two opposite transversal edges. A remaining edge portion, at the periphery of the rollable curtain member, extending about 5 to 10 percent of the distance may according to some examples be without the first fold line.

According to some embodiments, the first fold line may divide the rollable curtain member such that each of the first and the second segments extends in width between two opposite parallel lateral edges, such that the rollable curtain member is foldable between a lateral edge of the first segment and a lateral edge of the second segment.

A more well-defined and compact folding of the rollable door curtain may thereby be provided.

According to some embodiments, the rollable curtain member may comprise a second fold line forming an indentation into said rollable curtain member, wherein the second fold line divides the rollable curtain member into a second segment and a third segment, and wherein the rollable curtain member is foldable, along the second fold line, between an unfolded state, in which the second and the third segments are arranged in the same plane and a folded state, in which the second and the third segments are folded at least partly on top of each other. A larger rollable door curtain may thereby be provided that is foldable in an efficient manner. A larger freedom to fold the rollable door curtain is thereby achieved.

The second fold line may have the same characteristics as the first fold line. The features and advantages of the first fold line may be applicable to the second fold line as well.

According to some embodiments, the second fold line may divide the rollable curtain member such that each of the second and the third segments extends in width between two opposite parallel lateral edges, such that the rollable curtain member is foldable between a lateral edge of the second segment and a lateral edge of the third segment.

According to some embodiments, the rollable curtain member may extend in a longitudinal direction X1 between two opposite transversal edges and wherein the second fold line span between the transversal edges and wherein the first and the second fold lines are parallel.

A larger rollable door curtain may thereby be provided that is efficiently foldable. A more compact folded rollable door curtain may moreover be achieved.

According to some embodiments, the rollable curtain member may have a curtain thickness TC, and wherein the first and/or second fold line comprises a thinning portion, the thinning portion having a thickness TP being smaller than the curtain thickness TC.

A possible advantage being that the thinning portion allows for improved bending of the rollable curtain member. A more compact folding may thereby be achieved. The tinning portion may have a flat profile. The tinning portion may alternatively have a tapered profile.

According to some embodiments, the first and/or second fold lines may comprise at least one crease score line.

The at least one crease score line allows for easier folding. A more well-defined fold may be achieved. Problems associated with fold cracking may further be mitigated. In more detail, the at least one crease score line may be achieved by crease scoring. Put differently, the crease scoring may be understood as a process which facilitates a folding. During the creasing the rollable door curtain is weakened along the fold line. In more detail, the crease scoring may create indents by applying pressure to reduce the material thickness on one or both sides of the material. The crease scoring may not pierce or cut through the material. An advantage being that the depth for the cut may be reduced in comparison with a cut score. A robust fold line may thereby be achieved. The crease score line may form a three-dimensional profile in the material. The folds created from such a process may be more flexible and precise. The first fold line and/or second fold line may comprise two or more crease score lines.

The at least one crease score line may create two distinct elements on the surfaces of the rollable curtain member. One surface may have a recess or indentation and the other opposite surface may have a protrusion or raise. The rollable curtain member may be folded into the raised side. A more well-defined and even fold may thereby be achieved. Problems associated with cracking along the fold line may moreover be reduced.

According to some embodiments, the first fold line may comprise a first cut and an opposite second cut, the first cut being arranged on a first surface of the rollable curtain member and the opposite second cut being arranged on a second surface of the rollable curtain member, the first and the second surfaces being opposite.

According to some embodiments, the second fold line may comprise a first cut and an opposite second cut, the first cut being arranged on a first surface of the rollable curtain member and the opposite second cut being arranged on a second surface of the rollable curtain member, the first and the second surfaces being opposite.

A possible advantage being that the folding of the rollable curtain member may be in two different opposite directions.

According to some embodiments, the rollable curtain member may be provided with a first surface and an opposite second surface, and wherein the first fold line is formed on the first surface and wherein the rollable curtain member is foldable, along the first fold line, such that the second surfaces of the first and the second segments are facing toward each other in the folded state.

A possible advantage being that the second surfaces of the rollable curtain member may be protected in the folded state. The folding along the first fold line further reduces problems associated with wrinkling or markings on the second surfaces.

According to some embodiments, the rollable curtain member may be provided with a first surface and an opposite second surface, wherein the second fold line is formed on the second surface and wherein the rollable curtain member is foldable, along the second fold line, such that the first surfaces of the second and the third segments are facing toward each other in the folded state.

According to some embodiments, the rollable curtain member may be foldable such that in the folded state the first and the second segments are at least partly on top and in contact with each other and the second and the third segments are at least partly on top and in contact with each other.

A possible advantage being that a more compact folding of the rollable door curtain is provided. The folding may be understood as a zig-zag folding or Z-folding. A more compact folding of the rollable door curtain is achieved. A reduced wear and or wrinkling of the segments of the rollable curtain member may thereby be obtained when folding the rollable door curtain.

According to some embodiments two adjacent segments may each comprise a weight portion, the weight portions being arranged at a bottom distal portion of the rollable door curtain, wherein the weight portions are separated from each other at a distance equal to or larger than the separation between the lateral edges of the adjacent segments.

A possible advantage being that the rollable door curtain may be efficiently folded with the weight portions attached thereto. A more compact folded rollable door curtain is thereby provided that is easier to handle and transport. The weight portions are arranged to provide a stretching force when the rollable door curtain is raised or lowered, i.e. rolled or unrolled during operation in a roll-up door assembly. The weight portions may have the desired weight to provide the stretching force. The weight portions may alternatively comprise pockets arranged to receive weights such as metal rods or similar materials or objects providing the desired stretching force.

According to a second aspect there is provided a roll-up door assembly for covering a door opening. The roll-up door assembly comprising the rollable door curtain as described above. The roll-up door assembly further comprising: a drum and an engine, wherein the rollable door curtain is attached to the drum at a top distal portion of the rollable door curtain and the engine is arranged to roll and unroll the rollable door curtain around the drum such that the rollable door curtain is movable along the longitudinal direction X1 to cover and uncover the door opening.

Effects and features of the second aspect are to a large extent analogous to those described above in connection with the first aspect. Embodiments mentioned in relation to the first aspect are largely compatible with the second aspect.

The top distal portion is to be understood as being arranged opposite to the bottom end portion of the rollable door curtain.

According to some embodiments the roll-up door assembly may comprise one or more weight portions that are attached to the bottom distal portions of one or more the segments. The one or more weight portions may be removably attached the one or more segments.

According to a third aspect there is provided a method for producing the rollable door curtain. The method comprises:
providing a rollable curtain member;
providing a first fold line in the rollable curtain member, the first fold line forming an indentation into the rollable curtain member, and wherein the first fold line divides the rollable curtain member into a first segment and a second segment, such that the rollable curtain member is foldable, along the first fold line, between an unfolded state, in which the first and the second segments are arranged in the same plane and a folded state, in which the first and the second segments are folded at least partly on top of each other. The rollable curtain member extends in a longitudinal direction X1 between two opposite transversal edges and wherein the first fold line spans between the transversal edges. The rollable curtain member being arranged to be rolled up or unrolled along the longitudinal direction X1 both upon being in the unfolded state or being in the folded state. In other words, the rollable curtain member is rollable around a rotation axis, the rotation axis being perpendicular to the longitudinal direction X1, both upon being in the unfolded state or being in the folded state.

Effects and features of the third aspect are to a large extent analogous to those described above in connection with the first and second aspects. Embodiments mentioned in relation to the first and second aspect are largely compatible with the third aspect.

According to some embodiments, the method may further comprise:
providing a second fold line in rollable curtain member, the second fold line forming an indentation into the rollable curtain member, and wherein the second fold line divides the rollable curtain member into a second segment and a third segment, such that the rollable curtain member is foldable, along the second fold line, between an unfolded state, in which the second and the third segments are arranged in the same plane and a folded state, in which the second and the third segments are folded at least partly on top of each other.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows generally a top view of a rollable door curtain for a roll-up door assembly, according to some embodiments of the present disclosure.

FIG. 2 shows generally a top view of a rollable door curtain for a roll-up door assembly, according to some embodiments of the present disclosure.

FIGS. 3a to 3d show generally side views of rollable door curtains for a roll-up door assembly, according to some embodiments of the present disclosure.

FIGS. 4a to 4g show generally side views of rollable door curtains for a roll-up door assembly, according to some embodiments of the present disclosure.

FIGS. 5a to 5c show generally perspective views of a rollable door curtain for a roll-up door assembly, according to some embodiments of the present disclosure.

FIG. 6 shows generally a perspective view of a roll-up door assembly according to some embodiments of the present disclosure.

FIG. 7 is a general block diagram showing a method for producing the rollable door curtain according to some embodiments of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

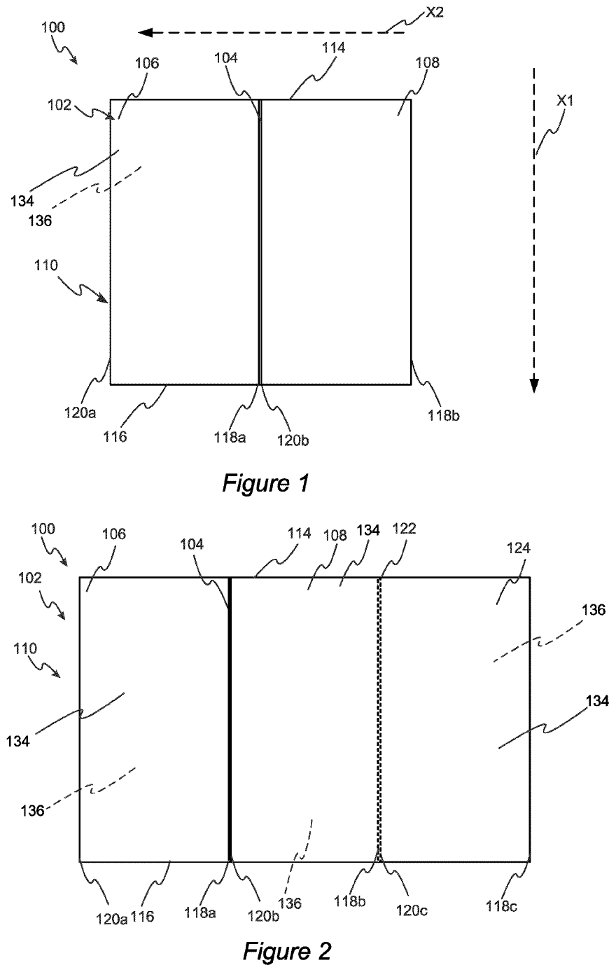

With reference to FIG. 1, a rollable door curtain 100 for a roll-up door assembly is illustrated. The rollable door curtain 100 comprises a rollable curtain member 102. The rollable curtain member 102 having a first fold line 104. The first fold line 104 forms an indentation into the rollable curtain member 102. The first fold line 104 divides the rollable curtain member 102 into a first segment 106 and a second segment 108. The segments 106, 108 are here illustrated to have the same shape and size but may in other embodiments differ in shape and/or size.

The rollable curtain member 102 is foldable along the first fold line 104. The first fold line 104 define where the rollable curtain member 102 is foldable. The first fold line 104 may be understood to act like a hinge. The rollable curtain member 102 is foldable along the fold line 104 between an unfolded state 110, in which the first and the second segments 106, 108 are arranged in the same plane and a folded state, in which the first and the second segments 106, 108 are folded at least partly on top of each other.

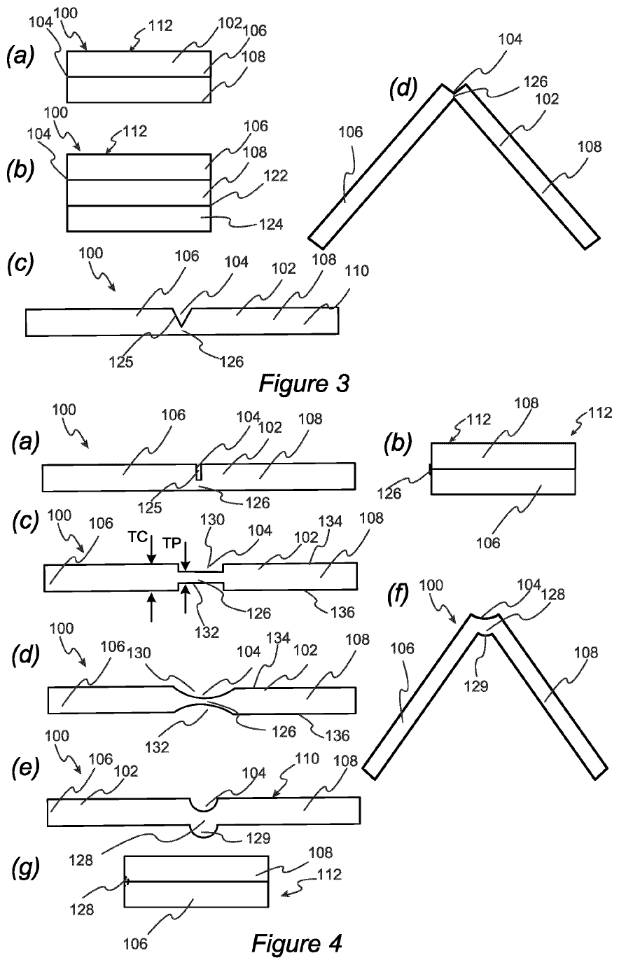

An advantage of the provided rollable door curtain 100 is that it is foldable in an efficient manner. FIG. 3a illustrates the rollable door curtain 100 of FIG. 1 in a folded state 112.

The rollable curtain member 102 extend in a longitudinal direction X1 between two opposite transversal edges 114, 116 and the first fold line 104 span between the transversal edges 114, 116 as illustrated in FIG. 1.

The rollable curtain member 102 is further arranged to be rolled up or unrolled along the longitudinal direction X1. The rollable door curtain 100 is moreover arranged to be rolled up or unrolled when folded. An easier handling of the rollable door curtain 100 is thereby achieved. The rollable door curtain 100 further arranged to be rolled up or unrolled in the unfolded state.

The first fold line 104 divides the rollable curtain member 102 such that each of the first and the second segments 106, 108 extends in width between two opposite parallel lateral edges 118a, 120a, and 118b, 120b. The rollable curtain member 102 is foldable between a lateral edge 118a of the first segment 106 and a lateral edge 120b of the second segment 108. The first and the second segments 106, 108, extend in width in a transversal direction transversal direction X2. The transversal direction X2 being perpendicular to the longitudinal direction X1.

With reference to FIG. 2, the rollable curtain member 102 may comprise a second fold line 122. The second fold line 122 forming an indentation into the rollable curtain member 102. The second fold line 122 divides the rollable curtain member 102 into a second segment 108 and a third segment 124. The rollable curtain member 102 is foldable, along the second fold line 122, between an unfolded state 110, in which the second and the third segments 108, 124 are arranged in the same plane and a folded state, in which the second and third segments 108, 124 are folded at least partly on top of each other. A larger rollable door curtain 100 may thereby be provided that is foldable in an efficient manner.

The second fold line 122 divides the rollable curtain member 102 such that each of the second and the third segments 108, 124 extends in width between two opposite parallel lateral edges 118b, 120b, and 118c, 120c. The rollable curtain member 102 is thereby foldable between a lateral edge 118b of the second segment 108 and a lateral edge 120c of the third segment 124. FIG. 3b illustrates the rollable door curtain 100 of FIG. 2 in a folded state 112.

In other words, the first fold line 104 and the second fold line 122 divide the rollable curtain member 102 into several segments that may be folded on top of each other. An easier handling of the rollable door curtain 100 may thereby be provided.

The rollable curtain member 102 extends in a longitudinal direction X1 between two opposite transversal edges 114, 116 and wherein the second fold line 122 span between the transversal edges 114, 116 and wherein the first and the second fold lines 104, 122 are parallel. A more compact folded rollable door curtain 100 may thereby be provided.

With reference to FIGS. 1 and 2, the rollable curtain member 102 may be provided with a first surface 134 and an opposite second surface 136. The first and the second surfaces 134, 136 being separated by the thickness of the rollable curtain member 102. The first fold line 104 may be formed on the first surface 134. The rollable curtain member 102 may thereby be foldable, along the first fold line 104, such that the second surfaces 136 of the first and the second segments 106, 108 are facing toward each other in the folded state.

To this end, the second fold line 122 may be formed on the second surface 136. The rollable curtain member 102 may thereby be foldable, along the second fold line 122, such that the first surfaces 134 of the second and third segments 108, 124 are facing toward each other in the folded state 112. A rollable door curtain 102 may be provided that is foldable such that in the folded state 112 the first and second segments 106, 108 are at least partly on top and in contact with each other and the second and third segments 108, 124 are at least partly on top and in contact with each other, see FIG. 3b.

FIGS. 3c and 3d illustrate a rollable door curtain 100 according to some embodiments. The rollable door curtain 100 comprises a rollable curtain member 102. A first fold line 104 is further formed in the rollable curtain member 102. The first fold line 104 divides the rollable curtain member 102 into a first segment 106 and a second segment 108. The fold line 104 is here exemplified as a cut 125. The cut has a V-shaped profile. The cut 125 may have other shapes according to other embodiments. The cut 125 may, for example, be U-shaped or square shaped. The cut 125 is extending partially through the rollable curtain member 102 leaving a thinning portion 126. Put differently, the cut 125 is extending a part of the thickness of the rollable curtain member 102. The rollable curtain member 102 is foldable along the first fold line 104. The rollable curtain member 102 is foldable at the thinning portion 126, as illustrated in the intermediate folding state of FIG. 3d.

FIGS. 4a to 4f illustrate rollable door curtains 100 according to some embodiments. With reference to FIGS. 4a and 4b, the rollable door curtain 100 comprises a rollable curtain member 102. A first fold line 104 is further formed in the rollable curtain member 102. The first fold line 104 divides the rollable curtain member 102 into a first segment 106 and a second segment 108. The fold line 104 is here exemplified as a cut 125. The cut has a square-shaped profile. The cut 125 is partial through the rollable curtain member 102 leaving a thinning portion 126. The rollable curtain member 102 is foldable along the first fold line 104. The thinning portion 126 may act as a hinge in the folding, as illustrated in FIG. 4b. The thinning portion 126 may, by way of example, form a protrusion in the folded state 112.

FIG. 4c illustrates a rollable door curtain 100 according to some embodiments. The rollable door curtain 100 comprises a rollable curtain member 102. A thinning portion 126 is formed in the rollable curtain member 102. In more detail, the rollable curtain member 102 has a curtain thickness TC and the first fold line 104 comprises a thinning portion 126 having a thickness TP. The thinning portion thickness TP is smaller than the curtain thickness TC.

FIG. 4d illustrates a rollable door curtain 100 according to some embodiments. The rollable curtain member 102 of the rollable door curtain 100 comprises a thinning portion 126. The tinning portion 126 is here, by way of example, illustrated as having a U-shape.

With reference to FIGS. 4 c and 4 d, the first fold line 104 may comprise a first cut 130 and an opposite second cut 132. The thinning portion 126 may be thereby be formed by cuts 130, 132 in opposite surfaces 134, 136 of the rollable curtain member 102. The first cut 130 may be arranged on a first surface 134 of the rollable curtain member 102 and the opposite second cut 132 may be arranged on a second surface 136 of the rollable curtain member 102. The first and the second surfaces 134, 136 being opposite. Put differently, the tinning portion 126 may be formed by two opposite recesses.

FIGS. 4e to 4g illustrate rollable door curtain 100 according to some embodiments. FIG. 4e illustrates the rollable door curtain 100 in an unfolded state 110. The rollable door curtain 100 comprises a rollable curtain member 102 having a first fold line 104. The first fold line 104 is illustrated to comprise at least one crease score line 128. The first fold line 104 may thereby act as a hinge for folding the rollable curtain member 102.

The at least one crease score line 128 may form two distinct elements on the surfaces of the rollable curtain member 102. One surface may have an indentation and the other opposite surface has a protrusion 129. The rollable curtain member 102 may advantageously be folded into the surface having the protrusion 129, as illustrated by the partial folding in FIG. 4f. FIG. 4g illustrates the rollable door curtain 100 of FIGS. 4e and 4f in a folded state 112. A compact folded rollable door curtain 100 may thereby be provided.

By way of example, the at least one crease score line 128 may be achieved by use of a ceasing rule pressed against the rollable curtain member 102. The rollable curtain member 102 may be placed on a make-ready. The at least one crease score line 128 may be parallel to fibres in the rollable curtain member 102. The rollable curtain member 102 may be understood to be compressible.

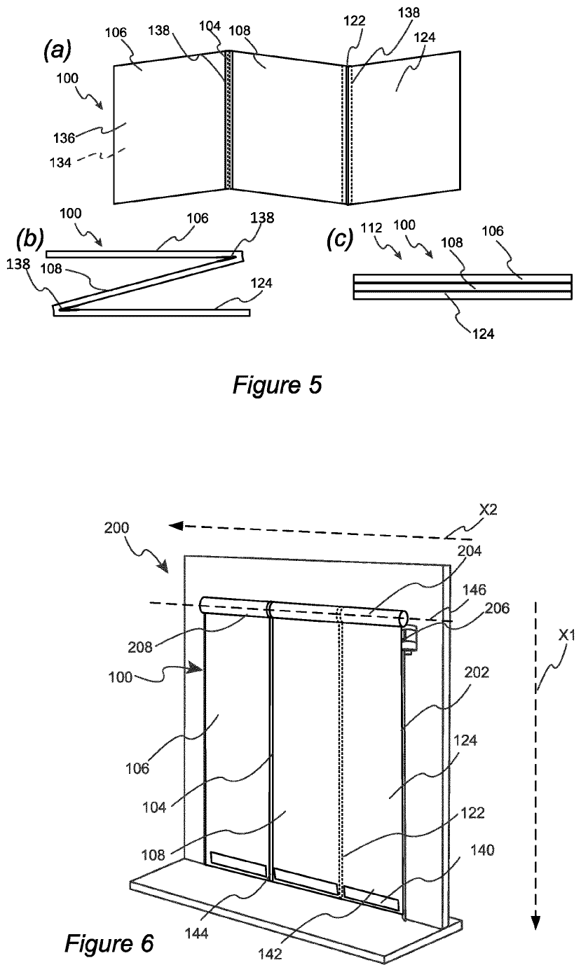

FIGS. 5a to 5c show generally perspective views of a rollable door curtain for a roll-up door assembly according to some embodiments. The rollable door curtain 100 comprises a rollable curtain member 102. The rollable curtain member 102 having a first fold line 104 forming an indentation into the rollable curtain member 102. The first fold line 104 divides the rollable curtain member 102 into a first segment 106 and a second segment 108. The rollable curtain member 102 is foldable along the fold line 104 between an unfolded state, in which the first and the second segments 106, 108 are arranged in the same plane and a folded state 112, in which the first and the second segments 106, 108 are folded at least partly on top of each other.

As illustrated in FIG. 5a, the rollable curtain member 102 may comprise a second fold line 122. The second fold line 122 forming an indentation into the rollable curtain member 102. The second fold line 122 divides the rollable curtain member 102 into a second segment 108 and a third segment 124. The rollable curtain member 102 is foldable along the second fold line 122.

FIG. 5b illustrates an intermediates state of the folding of the rollable door curtain 100. In more detail, the rollable curtain member 102 is foldable, along the second fold line 122, between an unfolded state, in which the second and third segments 108, 124 are arranged in the same plane and a folded state, in which the second and third segments 108, 124 are folded at least partly on top of each other.

In more detail, FIG. 5a illustrates that the rollable curtain member 102 may be provided with a first surface 134 and an opposite second surface 136. The first fold line 104 is here exemplified to be formed on the first surface 134. The rollable curtain member 102 is thereby foldable, along the first fold line 104, such that the second surfaces 136 of the first and the second segments 106, 108 are facing toward each other in the folded state 112.

To this end, the second fold line 122 may be formed on the second surface 136. The rollable curtain member 102 may thereby be foldable, along the second fold line 122, such that the first surfaces 134 of the second and third segments 108, 124 are facing toward each other in the folded state 112.

The rollable door curtain 102 may thereby be foldable such that in the folded state 112 the first and second segments 106, 108 are at least partly on top and in contact with each other and the second and third segments 108, 124 are at least partly on top and in contact with each other, as illustrated in FIG. 5c. The folding may be understood as a zig-zag folding or Z-folding. A more compact folding of the rollable door curtain 100 may be achieved.

According to some embodiments, the rollable curtain member may comprise a support strip 138 attached thereto. The support strip 138 may overlap with the first and/or second fold lines, see FIGS. 5a and 5b.

An advantage being that a more rigid and robust fold line 104, 122 may be achieved. The support strip 138 may be flexible. The support strip 138 may be attached prior to the folding. The support strip 138 may alternatively be applied after the unfolding, for instance at the installation site of a rollable door curtain assembly. The support strip 138 may reinforce the rollable curtain member 102. Put differently, the support strip 138 may reinforce the part of the rollable curtain member 102 remaining in the first fold line 104 or the second fold line 122.

According to some embodiments, the providing of the first and/or second fold line may be obtained by cutting one or more cuts along the first and/or second fold line, respectively.

According to some embodiments, the first and/or second fold lines may form a straight line across the rollable curtain member. The folding along the first and/or second fold line may be 180°.

According to some embodiments, the first and/or second fold lines may be a perforated line. The perforated line may be fully or partly through the rollable curtain member.

According to some embodiments, the third segment may extend in the longitudinal direction X1 between two opposite transversal edges and wherein the second fold line span between the transversal edges of the second and the third segments.

It may further be noted that in other embodiments that rollable door curtain may comprise more than three segments. Correspondingly, the rollable curtain member may comprise more than two separate fold lines.

FIG. 6 shows a general perspective view of a roll-up door assembly according to some embodiments. The roll-up door assembly 200 comprises a rollable door curtain 100 as described arranged above a door opening 202. The roll-up door assembly 200 further comprises a drum 204 and an engine 206. The rollable door curtain 100 is attached to the drum 204 at a top distal portion 208 of the rollable door curtain 100. The engine 206 is arranged to drive a rotation of the drum 204. In more detail, the engine 206 is arranged to roll and unroll the rollable door curtain 100 around the drum 204 such that the rollable door curtain 100 is movable along the longitudinal direction X1 to cover and uncover the door opening 202.

The rotation of the drum 204 may be rotating around a rotational axis 146, the rotational axis being parallel to the transversal direction X2.

FIG. 6 further illustrates that two adjacent segments 106, 108, 124 formed by the first or second fold lines 104, 122 may each comprise a weight portion 140, the weight portions 140 being arranged at a bottom distal portion 142 of the rollable door curtain 100, wherein the weight portions 140 are separated from each other at a distance 144 equal to or larger than the separation between the lateral edges of the adjacent segments 106, 108, 124.

According to other embodiments the roll-up door assembly may comprise a rollable door segment having one or more weight portions that are attached to the second distal portions of one or more the segments. The one or more weight portions may be removably attached the one or more segments.

The rollable door curtain may further comprise a pair of retaining strips, the retaining strips being arranged at the distal lateral edges of the rollable door curtain.

The segments may be equipped with one or more windows or vision panels.

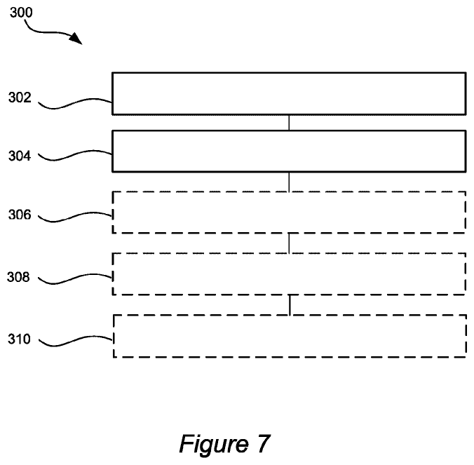

FIG. 7 illustrates, by way of example, a method for producing the rollable door curtain 100 according to some embodiments. The method 300 comprises: providing 302 a rollable curtain member 102 and providing 304 a first fold line 104 in the rollable curtain member 102. The first fold line 104 forms an indentation into the rollable curtain member 102. The first fold line 104 divides the rollable curtain member 102 into a first segment 106 and a second segment 108, such that the rollable curtain member 100 is foldable, along the first fold line 104, between an unfolded state 110, in which the first and second segments 106, 108 are arranged in the same plane and a folded state 112, in which the first and second segments 106, 108 are folded at least partly on top of each other, see FIG. 1.

The method 300 may further comprise: providing 306 a second fold line 122 in rollable curtain member 102. The second fold line 122 forms an indentation into the rollable curtain member 102, and wherein the second fold line 122 divides the rollable curtain member 102 into a second segment 108 and a third segment 124, such that the rollable curtain member 100 is foldable, along the second fold line 122, between an unfolded state 110, in which the second and the third segments 108, 124 are arranged in the same plane and a folded state 112, in which the second and the third segments 110, 112 are folded at least partly on top of each other, see FIG. 2.

The method may further comprise rolling 308 the folded rollable door curtain. Put differently, the method 300 may comprise rolling 308 the folded rollable curtain member 102. The rolling 308 may be around a rotation axis being perpendicular to the longitudinal direction X1.

According to some embodiments, the method 300 may comprise attaching 310 a support strip 138 to the rollable curtain member 102. The support strip 138 may overlap the first and/or the second fold lines 104, 122.

The rollable curtain member, may, by way of example, be made of polypropylene. The rollable curtain member may, in other examples, be made of any material conventionally used in rollable door curtains for a roll-up door assembly. The material may be a fabric of polyester or aramid fibres. The fibres may be impregnated with a polymer. The polymer may be PVC, polyurethane or silicone.

By way of example, the rollable curtain member may be made of a fabric. The fabric may comprise polyester, polyamide, glass fibre, polyolefin or aramide.

By way of example, the segments may be coated. The coating may comprise Silicone, Polyurethane, PVC, Acrylic, Phenolic, Rubber or Polyolefin. The segments may be made of coated fabrics. The support strip may be made of the same material as the rollable curtain member.

By way of example the thickness of the rollable curtain member may be in the order of 0.5 mm to 4 mm, preferable 0.8 mm to 1.2 mm.

According to some embodiments, the first and/or second fold lines may comprise a cut extending in depth partly through the rollable curtain member. The cut may be performed my cutting and/or milling of the rollable curtain member by which material is removed from the rollable curtain material to facilitate the folding.

According to some embodiments, the first and/or second fold lines may be formed by radio frequency milling.

According to some embodiments, the first and/or second fold lines may be formed by applying heat to locally melt the material.

The first and/or second fold lines may be provided by heat scoring or cold scoring.

The first and/or second fold line may extend in depth in the range of 10% to 60% of the thickness of the rollable curtain member, preferably between 20% to 40%.

A combination of cuts on opposite surfaces of the rollable curtain member may be preferred in some embodiments to increase the range of bending motion of the rollable curtain member.

By way of example the segments may be of the same width. The width may be in the range of 500 mm to 1 000 mm, preferably between 600 mm and 700 mm.

By way of example the segments may be of the same length. The length may be in the range of 2 000 mm to 5 000 mm, preferably between 3 000 mm and 4000 mm.

By way of example a rollable curtain member may have a width of 3 m. To transport a roll-up door curtain of such a dimension, there may therefore be required a packaging that is a bit longer. The rollable curtain member may however comprise three segments each having the width less than or about 1 m. The rollable door curtain be foldable such that it fits in a smaller packaging, e.g. in the order of a 1 m packaging.

The person skilled in the art realizes that the present disclosure is not limited to the preferred embodiments described above. The person skilled in the art further realizes that modifications and variations are possible within the scope of the appended claims. For example. Additionally, variations to the disclosed embodiments can be understood and effected by the skilled person in practicing the claimed disclosure, from a study of the drawings, the disclosure, and the appended claims.

1. A rollable door curtain (100) for a roll-up door assembly (200), the rollable door curtain (100) comprising:
a rollable curtain member (102) having a first fold line (104) forming an indentation into said rollable curtain member (102);
wherein the first fold line (104) divides the rollable curtain member (102) into a first segment (106) and a second segment (108);
wherein the rollable curtain member (102) is foldable, along the first fold line (104), between an unfolded state (110), in which the first and the second segments (106, 108) are arranged in the same plane and a folded state (112), in which the first and the second segments (106, 108) are folded at least partly on top of each other; and
wherein the rollable curtain member (102) extends in a longitudinal direction X1 between two opposite transversal edges (114, 116) and wherein the first fold line (104) spans between the transversal edges (114, 116), the rollable curtain member (102) being arranged to be rolled up or unrolled along the longitudinal direction X1 both upon being in the unfolded state (110) or being in the folded state (112).

2. The rollable door curtain according to claim 1, wherein the first fold line (104) divides the rollable curtain member (102) such that each of the first and the second segments (106, 108) extends in width between two opposite parallel lateral edges (118a, 120a, and 118b, 120b), such that the rollable curtain member (102) is foldable between a lateral edge (118a) of the first segment (106) and a lateral edge (120b) of the second segment (108).

3. The rollable door curtain according to claim 1, wherein the rollable curtain member (102) comprises a second fold line (122) forming an indentation into said rollable curtain member (102), wherein the second fold line (122) divides the rollable curtain member (102) into a second segment (108) and a third segment (124), and wherein the rollable curtain member (102) is foldable, along the second fold line (122), between an unfolded state (110), in which the second and the third segments (108, 124) are arranged in the same plane and a folded state (112), in which the second and the third segments (108, 124) are folded at least partly on top of each other.

4. The rollable door curtain according to claim 3, wherein the second fold line (122) divides the rollable curtain member (102) such that each of the second and the third segments (108, 124) extends in width between two opposite parallel lateral edges (118b, 120b, and 118c, 120c), such that the rollable curtain member (102) is foldable between a lateral edge (118b) of the second segment (108) and a lateral edge (120c) of the third segment (124).

5. The rollable door curtain according to claim 3, wherein the second fold line (122) span between the transversal edges (114, 116) and wherein the first and the second fold lines (104, 122) are parallel.

6. The rollable door curtain according to claim 3, wherein the rollable curtain member (102) has a curtain thickness TC, and wherein the first and/or second fold line (104, 122) comprises a thinning portion (126), the thinning portion (126) having a thickness TP being smaller than the curtain thickness TC.

7. The rollable door curtain according to claim 3, wherein the first and/or second fold lines (104, 122) comprises at least one crease score line (128).

8. The rollable door curtain according to claim 1, wherein the first fold line (104) comprises a first cut (130) and an opposite second cut (132), the first cut (130) being arranged on a first surface (134) of the rollable curtain member (102) and the opposite second cut (132) being arranged on a second surface (136) of the rollable curtain member (102), the first and the second surfaces (134, 136) being opposite.

9. The rollable door curtain according to claim 1, wherein the rollable curtain member (102) is provided with a first surface (134) and an opposite second surface (136), and wherein the first fold line (104) is formed on the first surface (134) and wherein the rollable curtain member (102) is foldable, along the first fold line (104), such that the second surfaces (136) of the first and the second segments (106, 108) are facing toward each other in the folded state (112).

10. The rollable door curtain according to claim 3, wherein the rollable curtain member (102) is provided with a first surface (134) and an opposite second surface (136), wherein the second fold line (122) is formed on the second surface (136) and wherein the rollable curtain member (102) is foldable, along the second fold line (122), such that the first surfaces (134) of the second and the third segments (108, 124) are facing toward each other in the folded state (112).

11. The rollable door curtain according to claim 10, wherein the rollable curtain member (102) is foldable such that in the folded state (112) the first and the second segments (106, 108) are at least partly on top and in contact with each other and the second and the third segments (108, 124) are at least partly on top and in contact with each other.

12. A roll-up door assembly (200) for covering a door opening (202), the roll-up door assembly (200) comprising: the rollable door curtain (100) according to claim 1, a drum (204) and an engine (206), wherein the rollable door curtain (100) is attached to the drum (204) at a top distal portion (208) of the rollable door curtain (100) and the engine (206) is arranged to roll and unroll the rollable door curtain (100) around the drum (204) such that the rollable door curtain (100) is movable along the longitudinal direction X1 to cover and uncover the door opening (202)

13. A method for producing the rollable door curtain (100) according to claim 1, wherein the method (300) comprises:
providing (302) the rollable curtain member (102);
providing (304) the first fold line (104) in the rollable curtain member (102), the first fold line (104) forming the indentation into the rollable curtain member (102), and wherein the first fold line (104) divides the rollable curtain member (102) into the first segment (106) and the second segment (108), such that the rollable curtain member (100) is foldable, along the first fold line (104), between the unfolded state (110), in which the first and the second segments (106, 108) are arranged in the same plane and the folded state (112), in which the first and the second segments (106, 108) are folded at least partly on top of each other, wherein the rollable curtain member (102) extends in the longitudinal direction X1 between the two opposite transversal edges (114, 116) and wherein the first fold line (104) spans between the transversal edges (114, 116), the rollable curtain member (102) being arranged to be rolled up or unrolled along the longitudinal direction X1 both upon being in the unfolded state (110) or being in the folded state (112).

14. The method for producing the rollable door curtain (100) according to claim 13, wherein the method (300) further comprises:
providing (306) a second fold line (122) in rollable curtain member (102), the second fold line (122) forming an indentation into the rollable curtain member (102), and wherein the second fold line (122) divides the rollable curtain member (102) into a second segment (108) and a third segment (124), such that the rollable curtain member (100) is foldable, along the second fold line (122), between an unfolded state (110), in which the second and the third segments (108, 124) are arranged in the same plane and a folded state (112), in which the second and the third segments (108, 124) are folded at least partly on top of each other.

15. The method for producing the rollable door curtain (100) according to claim 13, further comprising rolling (308) the folded rollable door curtain member (102) around a rotation axis being perpendicular to the longitudinal direction X1.
